(19) United States
(12) Patent Application Publication
(10) Pub. No.: US 2026/0223217 A1
(43) Pub. Date: Jul. 30, 2026

(54) CONNECTING BLUETOOTH DEVICES TO A BLUETOOTH CLUSTER

(71) Applicant: Cypress Semiconductor Corporation, San Jose, CA (US)

(72) Inventors: Ram Raja Kumar GEETHA VELUMAYIL STHANU, San Diego, CA (US); Arvind SRIDHARAN, San Diego, CA (US); James BEGGS, Ramona, CA (US); Manamohan MYSORE, Ramona, CA (US); Rohit GUPTA, New Delhi (IN); Raghavan AUYE VENUGOPAL, Bangalore (IN)

(73) Assignee: Cypress Semiconductor Corporation, San Jose, CA (US)

(21) Appl. No.: 19/281,467

(22) Filed: Jul. 25, 2025

Related U.S. Application Data
(60) Provisional application No. 63/749,382, filed on Jan. 24, 2025.

(51) Int. Cl. H04W 76/14; H04W 76/15

(52) U.S. Cl. CPC H04W 76/14; H04W 76/15

(57) ABSTRACT

A system includes a first node, a second node, and a backplane connection communicatively coupling the first node to the second node. The first node includes at least one first Bluetooth controller and stores a first affinity table storing first information for a plurality of Bluetooth devices including a preferred node for each Bluetooth device of the plurality of Bluetooth devices. The second node includes at least one second Bluetooth controller and stores a second affinity table storing second information for the plurality of Bluetooth devices including the preferred node for each Bluetooth device. Each respective node of the first node and the second node is configured to, in response to discovering a previously paired Bluetooth device of the plurality of Bluetooth devices, check the respective affinity table to determine the preferred node for the previously paired Bluetooth device; and connect the previously paired Bluetooth device to the preferred node.

### CROSS-REFERENCE TO RELATED APPLICATION

This application claims the benefit of U.S. Provisional Application No. 63/749,382, filed on Jan. 24, 2025, which is incorporated by reference herein.

### TECHNICAL FIELD

The present disclosure relates generally to Bluetooth clusters. More particularly, it relates to systems and methods for connecting Bluetooth devices to Bluetooth clusters.

### BACKGROUND

There are scenarios in which multiple peripheral devices are connected to a Bluetooth cluster including a plurality of nodes, such as an infotainment system. The multiple peripheral devices could include, for example, gaming audio devices (e.g., headphones, earbuds), voice chat devices (e.g., headphones, microphones), game controller devices, multi-stream audio playback devices, low latency karaoke devices, remote control devices, etc. To connect a device to the Bluetooth cluster, a user of the device initiates a pairing process to pair and connect the device to a first node of the Bluetooth cluster. To connect the device to a second node of the Bluetooth cluster, the user disconnects the device from the first node and reinitiates the pairing process to pair and connect the device to the second node of the Bluetooth cluster.

For these and other reasons, a need exists for the claimed subject matter.

### SUMMARY

Some examples of the present disclosure relate to a system. The system includes a first node, a second node, and a backplane connection. The first node includes at least one first Bluetooth controller and stores a first affinity table storing first information for a plurality of Bluetooth devices including a preferred node for each Bluetooth device of the plurality of Bluetooth devices. The second node includes at least one second Bluetooth controller and stores a second affinity table storing second information for the plurality of Bluetooth devices including the preferred node for each Bluetooth device. The backplane connection communicatively couples the first node to the second node. Each respective node of the first node and the second node is configured to, in response to discovering a previously paired Bluetooth device of the plurality of Bluetooth devices, check the respective affinity table to determine the preferred node for the previously paired Bluetooth device. Each respective node of the first node and the second node is further configured to connect the previously paired Bluetooth device to the preferred node.

Other examples of the present disclosure relate to an infotainment system. The infotainment system includes a plurality of nodes and a backplane communicatively coupling each of the plurality of nodes to each other. Each node of the plurality of nodes includes at least one respective Bluetooth controller and a respective affinity table storing information for a plurality of Bluetooth devices. The information includes a preferred node of the plurality of nodes for each Bluetooth device of the plurality of Bluetooth devices. Each respective node of the plurality of nodes is configured to, in response to discovering a previously paired Bluetooth device of the plurality of Bluetooth devices, check the respective affinity table to determine the preferred node for the previously paired Bluetooth device. Each respective node of the plurality of nodes is further configured to in response to the respective affinity table indicating the preferred node is the respective node, connect the previously paired Bluetooth device to the respective node. Each respective node of the plurality of nodes is further configured to in response to the respective affinity table indicating the preferred node is not the respective node, notify the preferred node to connect to the previously paired Bluetooth device. Each respective node of the plurality of nodes is further configured to in response to receiving a notification to connect to a previously paired Bluetooth device, connect the previously paired Bluetooth device to the respective node.

Yet other examples of the present disclosure relate to a method. The method includes initially pairing and connecting a Bluetooth device to a first node of a plurality of nodes within a Bluetooth cluster. The method further includes disconnecting the Bluetooth device from the first node. The method further includes connecting the Bluetooth device to a second node of the plurality of nodes within the Bluetooth cluster without pairing the Bluetooth device with the second node.

### BRIEF DESCRIPTION OF THE DRAWINGS

FIG. 1A is a block diagram illustrating an example system including a plurality of nodes for communicating with a plurality of Bluetooth devices.

FIG. 1B is a block diagram illustrating example user interfaces for the system of FIG. 1A.

FIG. 1C is a block diagram illustrating example Bluetooth devices for the system of FIG. 1A.

FIG. 2 is a block diagram illustrating an example method for connecting a Bluetooth device to a node in the system of FIG. 1A.

FIG. 3 is a block diagram illustrating an example method for updating a preferred node for a Bluetooth device in the system of FIG. 1A.

FIGS. 4A-4D are flow diagrams illustrating example methods for connecting a Bluetooth device to a node.

FIGS. 5A-5D are flow diagrams illustrating further example methods for connecting a Bluetooth device to a node.

FIG. 6 is a schematic diagram illustrating an example vehicle infotainment system.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

An infotainment system or Bluetooth cluster, such as a vehicle infotainment system, may connect via Bluetooth to headphones, mobile phones, game controllers, microphones, remotes, and/or other devices. For example, the vehicle infotainment system may simultaneously support a co-op gaming application including two users each with a connected gaming controller and headphones for gaming audio and voice chat, mobile phone streaming audio or call control, an infotainment remote, and a microphone for phone calls, voice chat, or karaoke. The infotainment system may include multiple infotainment units or nodes (e.g., driver, co-driver, rear seat passengers, etc.). Typically, to connect a device to the infotainment system or Bluetooth cluster, a user of the device initiates a pairing process to pair and connect the device to a first unit or node of the infotainment system or Bluetooth cluster. To connect the device to a second unit or node of the infotainment system or Bluetooth cluster, the user disconnects the device from the first unit or node and reinitiates the pairing process to pair and connect the device to the second unit or node of the infotainment system or Bluetooth cluster. Therefore, a pairing process is used each time a user desires to connect a device to a different unit or node of the infotainment system or Bluetooth cluster.

Accordingly, disclosed herein are systems and methods for pairing a device with an infotainment system or Bluetooth cluster a single time, which enables the device to connect to any unit or node within the infotainment system or Bluetooth cluster without going through the pairing process again. That is, once a device is initially paired and connected with a first unit or node within the infotainment system or Bluetooth cluster, the device connection may be moved to a second unit or node within the infotainment system or Bluetooth cluster without the user having to disconnect the device from the first unit or node and without the user having to pair and connect the device to the second unit or node.

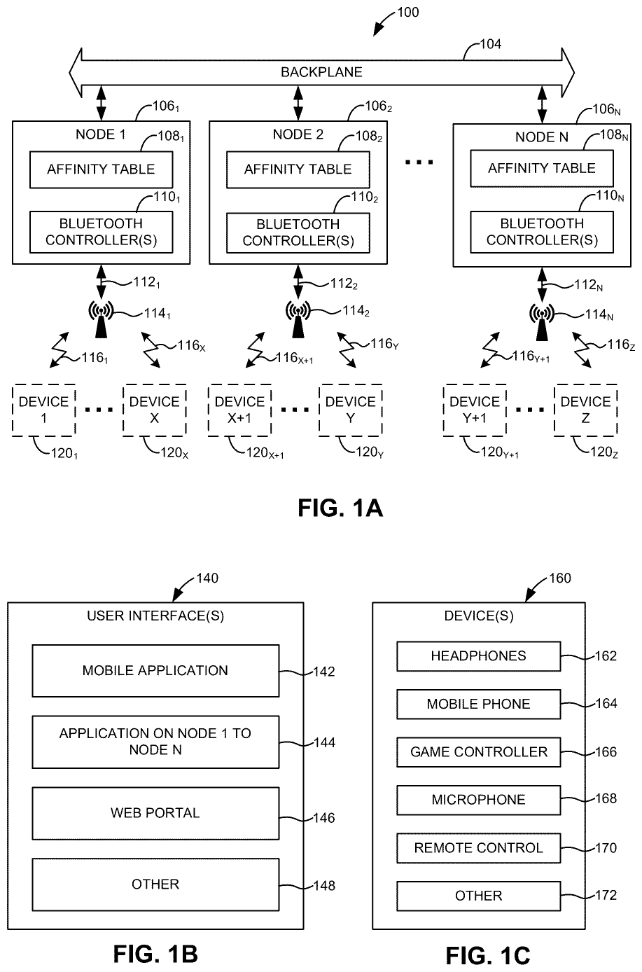

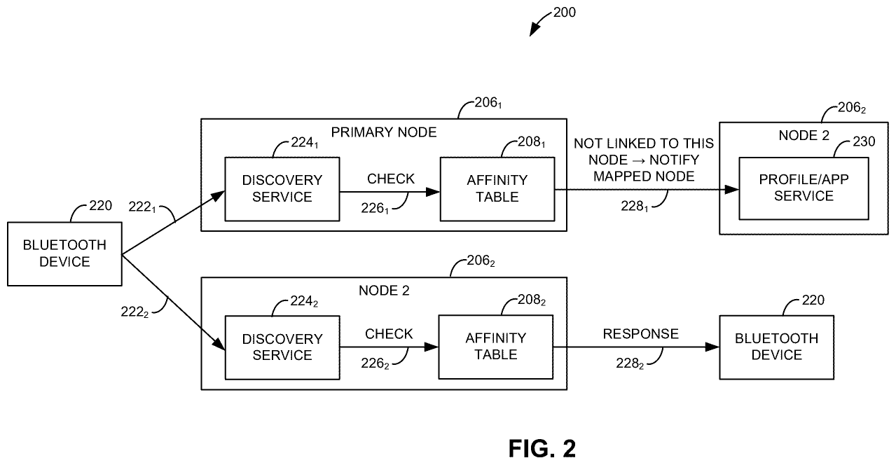

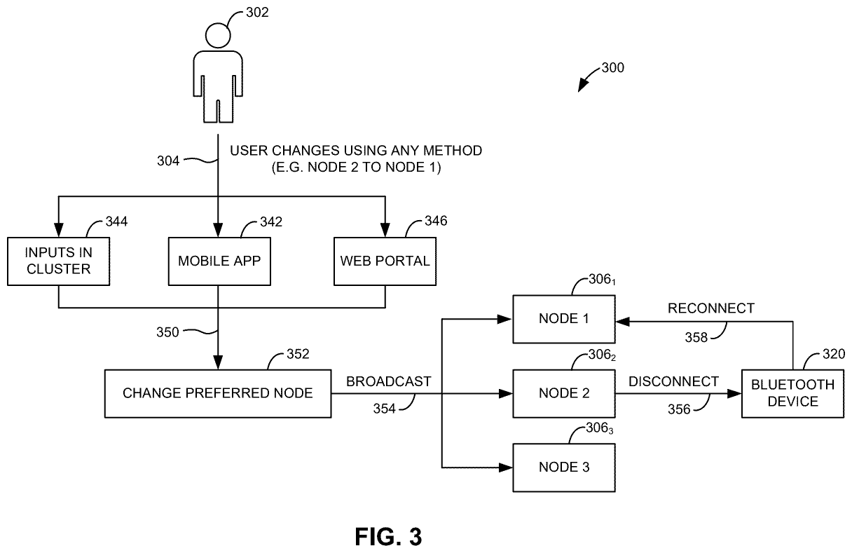

FIG. 1A is a block diagram illustrating an example system 100. System 100 includes a backplane 104, a plurality of nodes 106₁ to 106_{N}, where “N” is any suitable number of nodes (e.g., 2, 3, 4, 5, 6, 7, 8, or more), and a plurality of external (e.g., peripheral, peer, Bluetooth, etc.) devices 120₁ to 120_{Z}. Backplane 104 communicatively couples the plurality of nodes 106₁ to 106_{N} to each other. In some examples, backplane 104 includes a wired backplane connection, such as a controller area network (CAN), ethernet, RS232, etc. In some examples, backplane 104 includes a wireless backplane connection, such as a wireless local area network (WLAN), Bluetooth, etc.

Each node 106₁ to 106_{N} may store a respective affinity table 108₁ to 108_{N} and includes at least one (e.g., single or multiple) respective Bluetooth controller(s) 110₁ to 110_{N}. Each Bluetooth controller(s) 110₁ to 110_{N} may utilize a Bluetooth Low Energy (BLE) or classic Bluetooth protocol to support simultaneous connections to multiple devices. Each Bluetooth controller(s) 110₁ to 110_{N} is communicatively coupled to an antenna circuit 114₁ to 114_{N} through a communication path 112₁ to 112_{N}, respectively. Antenna circuits 114₁ to 114_{N} may be communicatively coupled to a plurality of external devices 120₁ to 120_{Z}. For example, antenna circuit 114₁ may be communicatively coupled to external devices 120₁ to 120_{X} through wireless (e.g., Bluetooth) communication paths 116₁ to 116_{X}, respectively, where “X” is any suitable number of external devices (e.g., 1, 2, 3, 4, 5, 6, or more). Antenna circuit 114₂ may be communicatively coupled to external devices 120_{X+1} to 120_{Y} through wireless (e.g., Bluetooth) communication paths 116ₓ₊₁ to 116_{Y}, respectively, where “Y” is any suitable number of additional external devices greater than X, (e.g., an additional 1, 2, 3, 4, 5, 6, or more devices). Likewise, antenna circuit 114_{N} may be communicatively coupled to external devices 120_{Y+1} to 120_{Z} through wireless (e.g., Bluetooth) communication paths 116_{Y+1} to 116_{Z}, respectively, where “Z” is any suitable number of additional external devices greater than Y, (e.g., an additional 1, 2, 3, 4, 5, 6, or more devices). Accordingly, system 100 including nodes 106₁ to 106_{N} may be communicatively coupled to a plurality of external devices 120₁ to 120_{Z} through the Bluetooth controller(s) 110₁ to 110_{N} to enable multiple connected devices.

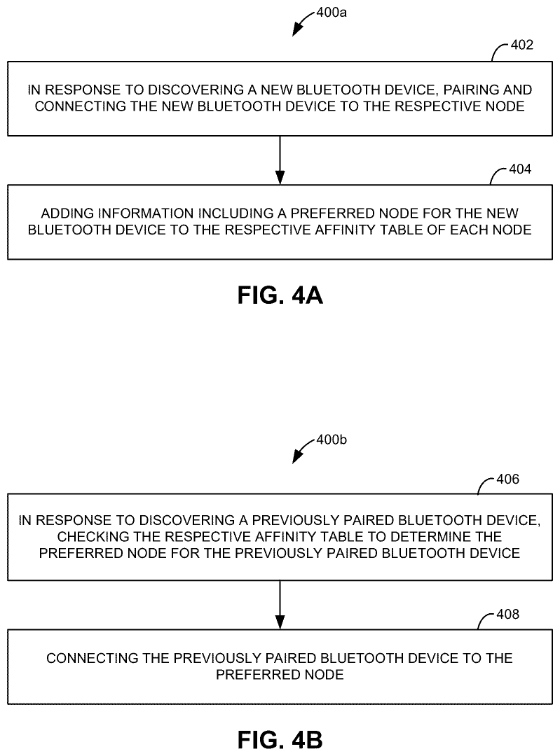

Each respective affinity table 108₁ to 108_{N} stores information for each of the plurality of Bluetooth devices 120₁ to 120_{Z}. Each respective affinity table 108₁ to 108_{N} may be stored in a non-volatile memory of the respective node 106₁ to 106_{N}. The stored information includes a preferred node of the plurality of nodes 106₁ to 106_{N} for each Bluetooth device 120₁ to 120_{Z}. As further described below with reference to FIGS. 2-5D, the preferred node for each Bluetooth device 120₁ to 120_{Z} indicates which node 106₁ to 106_{N} the Bluetooth device should be connected to upon discovery of the Bluetooth device after initial pairing of the Bluetooth device to the system 100. The information stored in each affinity table 108₁ to 108_{N} for each node 106₁ to 106_{N} also includes a Bluetooth address, a logical transport address (LT_ADDR), an access address, and a channel map for each Bluetooth device 120₁ to 120_{Z}. The Bluetooth address may be a unique 48-bit identifier for the Bluetooth device for recognizing and connecting to the respective Bluetooth device 120₁ to 120_{Z}. The LT_ADDR may be an identifier used to route communications between a respective Bluetooth controller 110₁ to 110_{N} and the respective devices 120₁ to 120_{X}, 120_{X+1} to 120_{Y}, and 120_{Y+1} to 120_{Z}. The access address may be used to facilitate secure and organized communication between a respective Bluetooth controller 110₁ to 110_{N} and the respective devices 120₁ to 120_{X}, 120_{X+1} to 120_{Y}, and 120_{Y+1} to 120_{Z}. The channel map may specify which frequency channels are used for communication between a respective Bluetooth controller 110₁ to 110_{N} and the respective devices 120₁ to 120_{X}, 120_{X+1} to 120_{Y}, and 120_{Y+1} to 120_{Z} to ensure reliable data exchange by avoiding interference. In some examples, the information stored in each affinity table 108₁ to 108_{N} for each node 106₁ to 106_{N} may also include typical pairing/bonding data for each Bluetooth device 120₁ to 120_{Z}, such as a link key, a device name, a class of device (CoD), pairing mode information, service discovery protocol (SDP) data, encryption parameters, connection parameters, trusted status, and/or bonding information. It is noted that each affinity table 108₁ to 108_{N} for each node 106₁ to 106_{N} persistently stores information not typically persistently stored by Bluetooth clusters (e.g., infotainment systems) including at least the preferred node, the logical transport address (LT_ADDR), the access address, and the channel map.

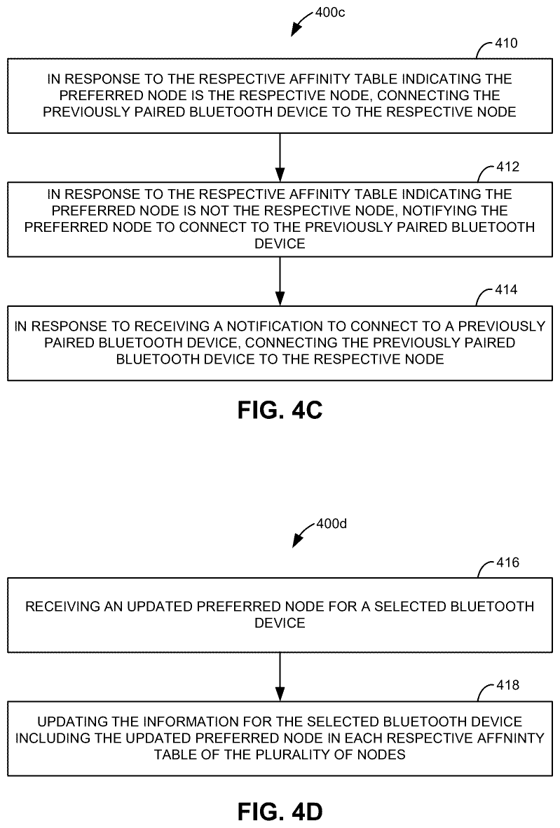

FIG. 1B is a block diagram illustrating example user interfaces 140 for the system 100 of FIG. 1A. A user interface 140 may be used to interact with system 100 (e.g., for entertainment functions), configure system 100, and/or adjust settings of system 100. In some examples as further described below with reference to FIGS. 3, 4D, and 5C, user interface 140 may be used to change a preferred node for a Bluetooth device 120₁ to 120_{Z} stored in each affinity table 108₁ to 108_{N} of each node 106₁ to 106_{N}, respectively. The user interface may include a mobile application 142, an application 144 on (e.g., hosted by) a node 106₁ to 106_{N}, a web portal 146, and/or other 148. Mobile application 142 may be an application on one of devices 120₁ to 120_{Z} (e.g., mobile phone, tablet, etc.) or an application on another device (e.g., mobile phone, tablet, etc.) communicatively coupled to system 100 (e.g., via Wi-Fi, cellular network, satellite network, etc.). The application 144 on a node 106₁ to 106_{N} may be accessed via an input (e.g., touchscreen, remote control, microphone, keypad, etc.) and/or via an output (e.g., screen, speaker, etc.) of the node. The web portal 146 may be accessed by any web enabled device (e.g., mobile phone, tablet, computer, etc.) and may be hosted by a server. The server hosting the web portal may be communicatively coupled to system 100 via a wired (e.g., wide area network, local area network, etc.) or wireless connection (e.g., Wi-Fi, cellular network, satellite network). Other 148 may include any other suitable device capable of communicating with system 100, such as a smart speaker, an internet of things device, an artificial intelligence (AI) assistant, etc.

FIG. 1C is a block diagram illustrating example Bluetooth devices 160 for the system of FIG. 1A. The Bluetooth devices 160 may provide any of devices 120₁ to 120_{Z} of FIG. 1A. The Bluetooth devices 160 may include headphones 162, a mobile phone 164, a game controller 166, a microphone 168, a remote control 170, and/or other 172 (e.g., speaker, tablet, laptop, smartwatch, camera, etc.).

FIG. 2 is a block diagram illustrating an example method 200 for reconnecting a Bluetooth device to a node in a system, such as in system 100 of FIG. 1A. In method 200, Bluetooth device 220 may be any device 120₁ to 120_{Z} of FIG. 1A, primary node 206₁ may be any one of nodes 106₁ to 106_{N} of FIG. 1A, and node two 206₂ may be any other one of nodes 106₁ to 106_{N} of FIG. 1A. For method 200, Bluetooth device 220 has previously been paired with the system and affinity tables 208₁ and 208₂ of nodes 206₁ and 206₂ (and the affinity tables of all other nodes within the system), respectively, include information for Bluetooth device 220 including the preferred node for Bluetooth device 220 as previously described.

Bluetooth device 220 may be discovered by a discovery service 224₂ of node 206₂ as indicated at 222₂. The Bluetooth device 220 may be discovered in response to powering on the device, enabling Bluetooth on the device, and/or bringing the device into range of node 206₂. In response to discovery service 224₂ of node 206₂ discovering Bluetooth device 220, discovery service 224₂ checks the affinity table 208₂ of node 206₂ as indicated at 226₂. In response to the affinity table 208₂ indicating that node 206₂ is the preferred node for Bluetooth device 220, node 206₂ connects to Bluetooth device 220 as indicated at 228₂.

Alternatively, Bluetooth device 220 may be discovered by a discovery service 224₁ of node 206₁ as indicated at 222₁. The Bluetooth device 220 may be discovered in response to powering on the device, enabling Bluetooth on the device, and/or bringing the device into range of node 206₁. In response to discovery service 224₁ of node 206₁ discovering Bluetooth device 220, discovery service 224₁ checks the affinity table 208₁ of node 206₁ as indicated at 226₁. In response to the affinity table 208₁ indicating that node 206₁ is not the preferred node for Bluetooth device 220 and that node 206₂ is the preferred node for Bluetooth device 220, node 206₁ notifies a profile/application service 230 of node 206₂ to connect to Bluetooth device 220 as indicated at 228₁. In response to receiving the notification, node 206₂ starts the discovery process via discovery service 224₂ and discovers Bluetooth device 220 as indicated at 222₂. As previously described, in response to discovery service 224₂ of node 206₂ discovering Bluetooth device 220, discovery service 224₂ checks the affinity table 208₂ of node 206₂ as indicated at 226₂. In response to the affinity table 208₂ indicating that node 206₂ is the preferred node for Bluetooth device 220, node 206₂ connects to Bluetooth device 220 as indicated at 228₂.

FIG. 3 is a block diagram illustrating an example method 300 for updating a preferred node for a Bluetooth device in a system, such as in system 100 of FIG. 1A. In method 300, Bluetooth device 320 may be any device 120₁ to 120_{Z} of FIG. 1A, and each node 306₁ to 306₃ may be any one of nodes 106₁ to 106_{N} of FIG. 1A. For method 300, Bluetooth device 320 has previously been paired with the system and the affinity tables of nodes 306₁ to 306₃ (and the affinity tables of all other nodes within the system) include information for Bluetooth device 320 including the preferred node for Bluetooth device 320 as previously described.

A user 302 may change the preferred node for Bluetooth device 320 using any one of inputs in the cluster 344 (e.g., via an application on any one of nodes 306₁ to 306₃ or other node within the system), a mobile application 342, or a web portal 346. For example, as indicated at 304, user 302 may change the preferred node for Bluetooth device 320 from node 306₂ to 306₁ via any one of inputs in cluster 344, mobile application 342, or web portal 346. The inputs in cluster 344, mobile application 342, or web portal 346 then communicate as indicated at 350 with a profile/application service of a node (e.g., a primary node, a unit, a host, etc.) to change the preferred node at 352. The preferred node is then broadcast as indicated at 354 to each node 306₁ to 306₃ (and all other nodes within the system) in the Bluetooth cluster and each node updates its respective affinity table with the preferred node for the Bluetooth device 320. In response to the preferred node for Bluetooth device 320 changing from node 306₂ to node 306₁, node 306₂ disconnects from Bluetooth device 320 as indicated at 356 and node 306₁ reconnects to Bluetooth device 320 as indicated at 358. The disconnection of Bluetooth device 320 from node 306₂ and the reconnection of Bluetooth device 320 to node 306₁ is implemented without user 302 involvement (e.g., user 302 does not go through a pairing process to pair and connect Bluetooth device 320 to node 306₁).

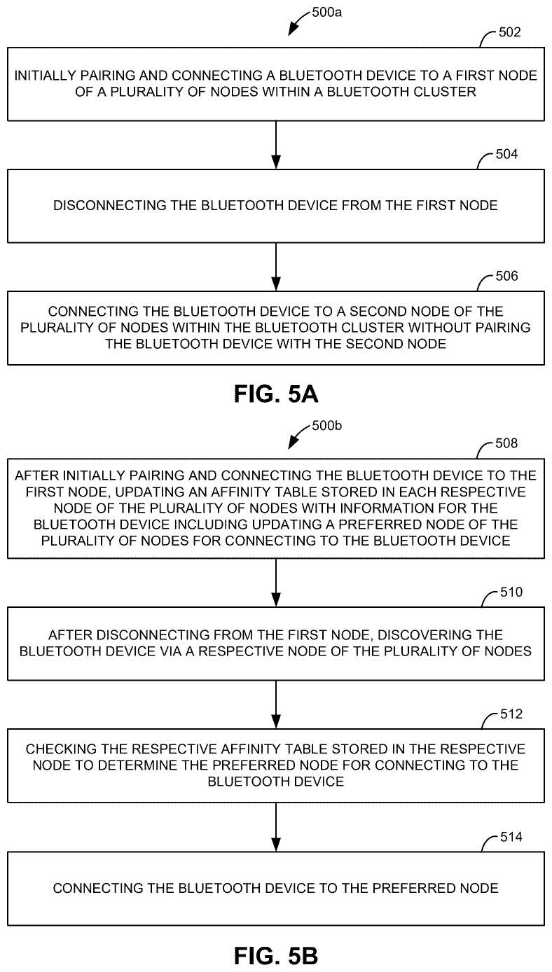

FIGS. 4A-4D are flow diagrams illustrating example methods 400a-400d for connecting a Bluetooth device (e.g., 120₁ to 120_{Z} of FIG. 1A) to a node (e.g., 106₁ to 106_{N} of FIG. 1A). Methods 400a-400d may be implemented by each respective node 106₁ to 106_{N} of FIG. 1A (e.g., by each respective Bluetooth controller 110₁ to 110_{N} and/or by a processing system or host of each node) in the Bluetooth cluster or infotainment system 100. As illustrated in FIG. 4A at 402, method 400a includes in response to discovering a new Bluetooth device (e.g., a device that has not been previously paired to system 100), pairing and connecting the new Bluetooth device to the respective node (e.g., to the node which discovered the device). At 404, method 400a includes adding information including a preferred node for the new Bluetooth device to the respective affinity table of each node (e.g., to each affinity table 108₁ to 108_{N} of FIG. 1A). In some examples, the preferred node of the new Bluetooth device is the node that initially discovered, paired, and connected to the new Bluetooth device.

In some examples, method 400a of FIG. 4A may further include method 400b of FIG. 4B. As illustrated in FIG. 4B at 406, method 400b includes in response to discovering a previously paired Bluetooth device (e.g., 120₁ to 120_{Z} of FIG. 1A), checking the respective affinity table (e.g., 108₁ to 108_{N} of FIG. 1A) to determine the preferred node for the previously paired Bluetooth device. At 408, method 400b includes connecting the previously paired Bluetooth device to the preferred node. In some examples, the preferred node for each Bluetooth device is user selected, such as via a user interface 140 of FIG. 1B.

In some examples, method 400b of FIG. 4B may further include method 400c of FIG. 4C. As illustrated in FIG. 4C at 410, method 400c includes in response to the respective affinity table indicating the preferred node is the respective node, connecting the previously paired Bluetooth device to the respective node. At 412, method 400c includes in response to the respective affinity table indicating the preferred node is not the respective node, notifying the preferred node to connect to the previously paired Bluetooth device. At 414, method 400c includes in response to receiving a notification to connect to a previously paired Bluetooth device, connecting the previously paired Bluetooth device to the respective node.

In some examples, method 400a of FIG. 4A, method 400b of FIG. 4B, and/or method 400c of FIG. 4C may further include method 400d of FIG. 4D. As illustrated in FIG. 4D at 416, method 400d includes receiving an updated preferred node for a selected Bluetooth device. At 418, method 400d includes updating the information for the selected Bluetooth device including the updated preferred node in each respective affinity table of the plurality of nodes. In some examples, each of the plurality of nodes (e.g., 106₁ to 106_{N}) are configured to connect to each of the plurality of Bluetooth devices (e.g., 120₁ to 120_{Z}) using the same respective Bluetooth address.

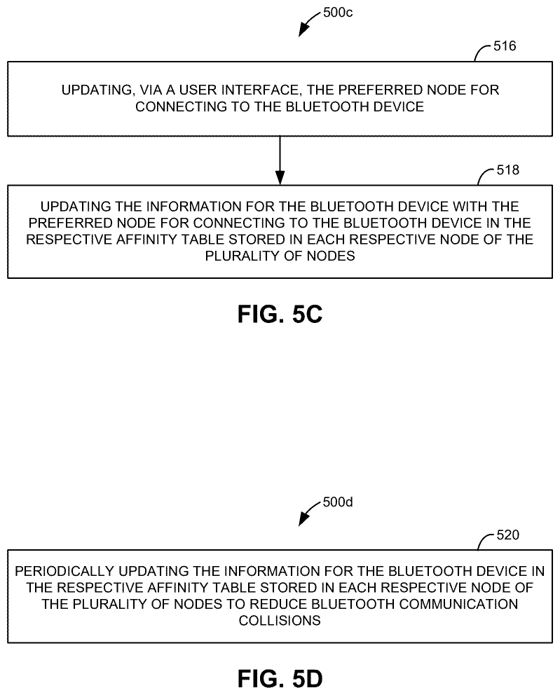

FIGS. 5A-5D are flow diagrams illustrating further example methods 500a-500d for connecting a Bluetooth device to a node. Methods 500a-500d may be implemented by nodes 106₁ to 106_{N} of FIG. 1A (e.g., by Bluetooth controllers 110₁ to 110_{N} and/or by a processing system or host of the nodes) in the Bluetooth cluster or infotainment system 100. As illustrated in FIG. 5A at 502, method 500a includes initially pairing and connecting a Bluetooth device (e.g., 120₁ to 120_{Z} of FIG. 1A) to a first node of a plurality of nodes (e.g., 106₁ to 106_{N} of FIG. 1A) within a Bluetooth cluster. At 504, method 500a includes disconnecting the Bluetooth device from the first node. At 506, method 500a includes connecting the Bluetooth device to a second node of the plurality of nodes within the Bluetooth cluster without pairing the Bluetooth device with the second node.

In some examples, method 500a of FIG. 5A may further include method 500b of FIG. 5B. As illustrated in FIG. 5B at 508, method 500b includes after initially pairing and connecting the Bluetooth device to the first node, updating an affinity table (e.g., 108₁ to 108_{N} of FIG. 1A) stored in each respective node of the plurality of nodes with information for the Bluetooth device including updating a preferred node of the plurality of nodes for connecting to the Bluetooth device. At 510, method 500b includes, after disconnecting from the first node, discovering the Bluetooth device via a respective node of the plurality of nodes. At 512, method 500b includes checking the respective affinity table stored in the respective node to determine the preferred node for connecting to the Bluetooth device. At 514, method 500b includes connecting the Bluetooth device to the preferred node.

In some examples, method 500a of FIG. 5A and/or method 500b of FIG. 5B may further include method 500c of FIG. 5C. As illustrated in FIG. 5C at 516, method 500c includes updating, via a user interface (e.g., 140 of FIG. 1B), the preferred node for connecting to the Bluetooth device. At 518, method 500c includes updating the information for the Bluetooth device with the preferred node for connecting to the Bluetooth device in the respective affinity table stored in each respective node of the plurality of nodes.

In some examples, method 500a of FIG. 5A, method 500b of FIG. 5B, and/or method 500c of FIG. 5C may further include method 500d of FIG. 5D. As illustrated in FIG. 5D at 520, method 500d includes periodically updating the information for the Bluetooth device in the respective affinity table (e.g., 108₁ to 108_{N} of FIG. 1A) stored in each respective node (e.g., 106₁ to 106_{N} of FIG. 1A) of the plurality of nodes to reduce Bluetooth communication collisions. For example, the logical transport address (LT_ADDR), the access address, the channel map, and/or other information for a Bluetooth device may be updated in the affinity table stored in each node to reduce Bluetooth communication collisions.

In some examples, a processing system of each node (e.g., 106₁ to 106_{N} of FIG. 1A) of a Bluetooth cluster (e.g., 100 of FIG. 1A) may perform the operations and methods described with reference to FIGS. 1A-5D. The processing system may include a processor and a machine-readable storage medium. The processor may be communicatively coupled to the machine-readable storage medium through a communication path. Although the following description refers to a single processor and a single machine-readable storage medium, the description may also apply to a system with multiple processors and multiple machine-readable storage mediums. In such examples, the data and instructions may be distributed (e.g., stored) across multiple machine-readable storage mediums and the instructions may be distributed (e.g., executed by) across multiple processors.

The processor may include one (i.e., a single) central processing unit (CPU) or microprocessor or more than one (i.e., multiple) CPU or microprocessor, and/or other suitable hardware devices for retrieval and execution of instructions stored in the machine-readable storage medium. The processor may fetch, decode, and execute instructions to implement the functions and methods described with reference to FIGS. 1A-5D.

As an alternative or in addition to retrieving and executing instructions, the processor may include one (i.e., a single) electronic circuit or more than one (i.e., multiple) electronic circuit comprising a number of electronic components for performing the functionality of one of the instructions or more than one of the instructions of the machine-readable storage medium. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

The machine-readable storage medium is a non-transitory storage medium and may be any suitable electronic, magnetic, optical, or other physical storage device that stores executable instructions. Thus, the machine-readable storage medium may be, for example, a random access memory (RAM), an electrically-erasable programmable read-only memory (EEPROM), a storage drive, an optical disc, and the like. The machine-readable storage medium may be disposed within each node of the Bluetooth cluster. In this case, the executable instructions may be installed on each node of the Bluetooth cluster. Alternatively, the machine-readable storage medium may be a portable, external, or remote storage medium that allows each node of the Bluetooth cluster to download the instructions from the portable/external/remote storage medium. In this case, the executable instructions may be part of an installation package.

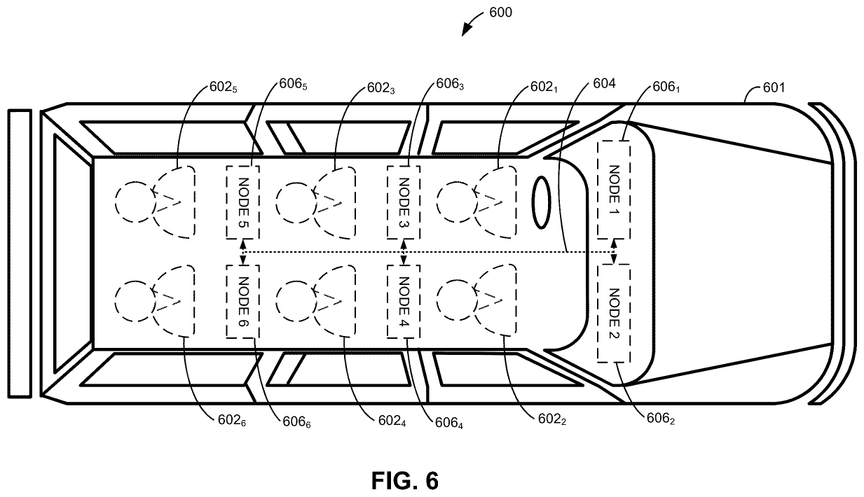

FIG. 6 is a schematic diagram illustrating an example vehicle infotainment system 600 within a vehicle 601. Vehicle infotainment system 600 includes nodes 606₁ to 606₆ and a backplane 604 communicatively coupling each of the nodes 606₁ to 606₆ to each other. In some examples, nodes 606₁ to 606₆ are similar to nodes 106₁ to 106_{N} of FIG. 1A, and backplane 604 is similar to backplane 104 of FIG. 1A. Vehicle infotainment system 600 operates similarly as system 100 as previously described with reference to FIGS. 1A-5D.

In some examples, each node 606₁ to 606₆ is associated with a different seat within the vehicle 601. Node 606₁ may be arranged for primary use by a driver 602₁, node 606₂ may be arranged for primary use by a front row passenger 602₂, node 606₃ may be arranged for primary use by a second row driver side passenger 602₃, node 606₄ may be arranged for primary use by a second row passenger side passenger 602₄, node 606₅ may be arranged for primary use by a third row driver side passenger 602₅, and node 606₆ may be arranged for primary use by a third row passenger side passenger 602₆. In some examples, vehicle infotainment system 600 may include less than six nodes or more than six nodes depending upon the configuration of the vehicle (e.g., number of rows, number of seats, etc.). In some examples, node 606₁ may be a primary node or head unit responsible for updating the affinity tables in each node 606₁ to 606₆ in response to a change in a preferred node as indicated at 352 in FIG. 3 and/or for periodically updating the affinity table in each node 606₁ to 606₆ to reduce Bluetooth communication collisions as described with reference to FIG. 5D.

It is to be understood that the features of the various example embodiments described herein may be combined with each other, unless specifically noted otherwise.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A system comprising:
a first node comprising at least one first Bluetooth controller and storing a first affinity table storing first information for a plurality of Bluetooth devices including a preferred node for each Bluetooth device of the plurality of Bluetooth devices;
a second node comprising at least one second Bluetooth controller and storing a second affinity table storing second information for the plurality of Bluetooth devices including the preferred node for each Bluetooth device; and
a backplane connection communicatively coupling the first node to the second node;
wherein each respective node of the first node and the second node is configured to:
in response to discovering a previously paired Bluetooth device of the plurality of Bluetooth devices, check the respective affinity table to determine the preferred node for the previously paired Bluetooth device; and
connect the previously paired Bluetooth device to the preferred node.

2. The system of claim 1, wherein each respective node of the first node and the second node is configured to:
in response to discovering a new Bluetooth device, pair and connect the new Bluetooth device to the respective node; and
add information including a preferred node for the new Bluetooth device to the first affinity table and the second affinity table.

3. The system of claim 1, wherein each respective node of the first node and the second node is configured to:
in response to the respective affinity table indicating the preferred node for the previously paired Bluetooth device is the respective node, connect the previously paired Bluetooth device to the respective node;
in response to the respective affinity table indicating the preferred node for the previously paired Bluetooth device is not the respective node, notify the preferred node to connect to the previously paired Bluetooth device; and
in response to receiving a notification to connect to a previously paired Bluetooth device, connect the previously paired Bluetooth device to the respective node.

4. The system of claim 1, wherein the preferred node for each Bluetooth device is user selected.

5. The system of claim 1, wherein the first node and the second node are configured to connect to each of the plurality of Bluetooth devices using a same respective Bluetooth address.

6. The system of claim 1, wherein each of the first information and the second information comprises a Bluetooth address, a logical transport address (LT_ADDR), an access address, and a channel map.

7. The system of claim 1, wherein the backplane connection comprises a wired backplane connection.

8. The system of claim 1, wherein the backplane connection comprises a wireless backplane connection.

9. An infotainment system comprising:
a plurality of nodes, each node of the plurality of nodes comprising at least one respective Bluetooth controller and a respective affinity table storing information for a plurality of Bluetooth devices, the information including a preferred node of the plurality of nodes for each Bluetooth device of the plurality of Bluetooth devices; and
a backplane communicatively coupling each of the plurality of nodes to each other;
wherein each respective node of the plurality of nodes is configured to:
in response to discovering a previously paired Bluetooth device of the plurality of Bluetooth devices, check the respective affinity table to determine the preferred node for the previously paired Bluetooth device;
in response to the respective affinity table indicating the preferred node is the respective node, connect the previously paired Bluetooth device to the respective node;
in response to the respective affinity table indicating the preferred node is not the respective node, notify the preferred node to connect to the previously paired Bluetooth device; and
in response to receiving a notification to connect to a previously paired Bluetooth device, connect the previously paired Bluetooth device to the respective node.

10. The infotainment system of claim 9, wherein each respective node of the plurality of nodes is configured to:
discover a new Bluetooth device;
initially pair and connect the new Bluetooth device to the respective node; and
add the information for the new Bluetooth device to each respective affinity table of the plurality of nodes.

11. The infotainment system of claim 10, further comprising:
a user interface communicatively coupled to the plurality of nodes, the user interface configured to:
receive an updated preferred node for a selected Bluetooth device of the plurality of Bluetooth devices; and
update the information for the selected Bluetooth device including the updated preferred node in each respective affinity table of the plurality of nodes.

12. The infotainment system of claim 11, wherein the user interface is implemented via a mobile application.

13. The infotainment system of claim 11, wherein the user interface is implemented via an application on a node of the plurality of nodes.

14. The infotainment system of claim 11, wherein the user interface is implemented via a web portal.

15. The infotainment system of claim 9, wherein the plurality of Bluetooth devices comprise headphones, a mobile phone, a game controller, a microphone, and/or a remote control.

16. The infotainment system of claim 9, wherein the infotainment system is a vehicle infotainment system within a vehicle, and
wherein each node of the plurality of nodes is associated with a different seat within the vehicle.

17. A method comprising:
initially pairing and connecting a Bluetooth device to a first node of a plurality of nodes within a Bluetooth cluster;
disconnecting the Bluetooth device from the first node; and
connecting the Bluetooth device to a second node of the plurality of nodes within the Bluetooth cluster without pairing the Bluetooth device with the second node.

18. The method of claim 17, further comprising:
after initially pairing and connecting the Bluetooth device to the first node, updating an affinity table stored in each respective node of the plurality of nodes with information for the Bluetooth device including updating a preferred node of the plurality of nodes for connecting to the Bluetooth device;
after disconnecting from the first node, discovering the Bluetooth device via a respective node of the plurality of nodes;
checking the respective affinity table stored in the respective node to determine the preferred node for connecting to the Bluetooth device; and
connecting the Bluetooth device to the preferred node.

19. The method of claim 18, further comprising:
updating, via a user interface, the preferred node for connecting to the Bluetooth device; and
updating the information for the Bluetooth device with the preferred node for connecting to the Bluetooth device in the respective affinity table stored in each respective node of the plurality of nodes.

20. The method of claim 18, further comprising:
periodically updating the information for the Bluetooth device in the respective affinity table stored in each respective node of the plurality of nodes to reduce Bluetooth communication collisions.
